(19) United States
(12) Patent Application Publication
(10) Pub. No.: US 2013/0066451 A1
(43) Pub. Date: Mar. 14, 2013

(54) SYSTEM AND METHOD FOR MITIGATING FREQUENCY MISMATCH IN A RECEIVER SYSTEM

(71) Applicants: Aravind Na Ganesan, Karnataka (IN); Sundarrajan Rangachari, Ulsoor (IN); Zahir Ibrahim Parkar, Karnataka (IN)

(72) Inventors: Aravind Na Ganesan, Karnataka (IN); Sundarrajan Rangachari, Ulsoor (IN); Zahir Ibrahim Parkar, Karnataka (IN)

(21) Appl. No.: 13/315,804

(22) Filed: Dec. 9, 2011

(30) Foreign Application Priority Data
Sep. 14, 2011 (IN) 3157/CHE/2011

(51) Int. Cl. G06F 17/00; H04B 1/10; H04B 1/06

(52) U.S. Cl. 700/94; 375/316; 375/346

(57) ABSTRACT

One embodiment of the invention includes a receiver system. The system includes a receiver that generates digital data samples corresponding to an analog signal at a sampling frequency associated with a first frequency reference and a host codec that reads the digital data samples at a read frequency associated with a second frequency reference. The system also includes a first-in first-out (FIFO) buffer that buffers the digital data samples via write commands associated with the receiver and read commands associated with the host codec. The FIFO buffer can have a current pointer state that is based on the relative write and read commands. The system further includes a frequency controller that calculates a frequency offset between the sampling frequency and the read frequency based on a rate of drift of the current pointer state relative to a predetermined calibration threshold and adjusts the sampling frequency based on the frequency offset.

### TECHNICAL FIELD

The present invention relates generally to digital systems, and specifically to a system and method for mitigating frequency mismatch in a receiver system.

### BACKGROUND

A received analog signal, such as a frequency modulated (FM) audio signal, can be received and decoded at a receiver system. The receiver system can sample the analog signal at a fixed rate that can be converted to a required sampling rate before being transmitted from a digital interface, such as an integrated interchip sound (I²S) interface. The digital interface sampler can convert the audio samples sampled at a given sampling frequency to a given supported output frequency. As an example, the samples can be read by a host device (e.g., a host codec) at a rate that is different from the sampling frequency of the digital interface sampler. This can happen due to the relative frequency error between frequency references (e.g., reference crystals). This causes mismatch in the read and write rates and causes overflow or underflow of the digital data samples, such as in a first-in first-out (FIFO) buffer. The overflow and/or underflow that can occur based on the frequency reference mismatches can cause degradation of signal-to-noise ratio (SNR) of the resulting digital signal.

### SUMMARY

One embodiment of the invention includes a receiver system. The system includes a receiver that generates digital data samples corresponding to an analog signal at a sampling frequency associated with a first frequency reference and a host codec that reads the digital data samples at a read frequency associated with a second frequency reference. The system also includes a first-in first-out (FIFO) buffer that buffers the digital data samples via write commands associated with the receiver and read commands associated with the host codec. The FIFO buffer can have a current pointer state that is based on the relative write and read commands. The system further includes a frequency controller that calculates a frequency offset between the sampling frequency and the read frequency based on a rate of drift of the current pointer state relative to a predetermined calibration threshold and adjusts the sampling frequency based on the frequency offset.

Another embodiment of the present invention includes a method for substantially reducing a signal-to-noise ratio of a received audio signal. The method includes generating digital data samples corresponding to the received audio signal and writing the digital data samples to a FIFO buffer via write commands at a sampling frequency associated with a first frequency reference. The method also includes reading the digital data samples from the FIFO buffer via read commands associated with a host codec at a read frequency associated with a second frequency reference, the FIFO buffer having a current pointer state that is based on the relative write and read commands. The method also includes calculating a frequency offset between the sampling frequency and the read frequency reference based on an amount of time taken for the current pointer state to achieve a predetermined calibration threshold. The method further includes adjusting the sampling frequency to maintain the current pointer state within a predetermined pointer state range based on the frequency offset.

Another embodiment of the present invention includes an audio receiver system. The system includes a receiver configured to generate digital data samples corresponding to a received audio signal at a sampling frequency associated with a first frequency reference and a host codec configured to read the digital data samples at a read frequency associated with a second frequency reference based on an integrated interchip sound (I²S) interface. The system also includes a first-in first-out (FIFO) buffer configured to buffer the digital data samples via write commands associated with the receiver and read commands associated with the host codec. The FIFO buffer can have a current pointer state that is based on the relative write and read commands. The system further includes a calibration component configured to determine a difference count value corresponding to a difference between relative occurrence of write commands and read commands, to calculate a frequency offset between the sampling frequency and the read frequency reference based on calculating a number of write commands until a predetermined calibration threshold is reached from the current pointer state based on the difference count value, and to adjust the sampling frequency based on the frequency offset.

### BRIEF DESCRIPTION OF THE DRAWINGS

FIG. 1 illustrates an example of a receiver system in accordance with an aspect of the invention.

FIG. 2 illustrates an example of a first-in-first-out (FIFO) buffer in accordance with an aspect of the invention.

FIG. 3 illustrates another example of a receiver system in accordance with an aspect of the invention.

FIG. 4 illustrates an example of a frequency controller in accordance with an aspect of the invention.

FIG. 5 illustrates an example of method for substantially increasing a signal-to-noise ratio (SNR) of a received audio signal in accordance with an aspect of the invention.

### DETAILED DESCRIPTION

The present invention relates generally to digital systems, and specifically to a system and method for mitigating frequency mismatch in a receiver system. The receiver system can include a receiver configured to receive an analog signal, such as an audio signal, and to generate digital data samples via a sampler at a sampling frequency that is based on a first frequency reference. The digital data samples can be written to a first-in first-out (FIFO) buffer via write commands. The digital data samples can be read from the FIFO buffer via read commands associated with a host device, such as a host codec, at a rate that is based on a second frequency reference. As an example, the read commands can be implemented based on an integrated interchip sound (I²S) interface. Therefore, the FIFO buffer can have a current pointer state that is based on the write commands relative to the read commands.

The receiver system can also include a calibration component that is configured to calculate a frequency offset between the sampling frequency and the second frequency reference and to adjust the sampling frequency based on a rate of change of the current pointer state resulting from the frequency offset relative to a predetermined calibration threshold. The calibration component can calculate an average count value that corresponds to a moving block average of a difference between relative occurrence of write commands to the FIFO and read commands from the FIFO. The calibration component can thus compare the average count value to the calibration threshold to determine when to initiate adjustment of the sampling frequency, and to calculate the frequency offset based on determining an amount of time that it took for the current pointer state to reach the calibration threshold based on a sample count value corresponding to a total number of write commands. Thus, the sampling frequency can be changed based on the frequency offset. In addition, the calibration component can be configured to add a digital bias to the calculated frequency offset, such as to move the current pointer state to within optimal thresholds that define an optimal set of pointer states.

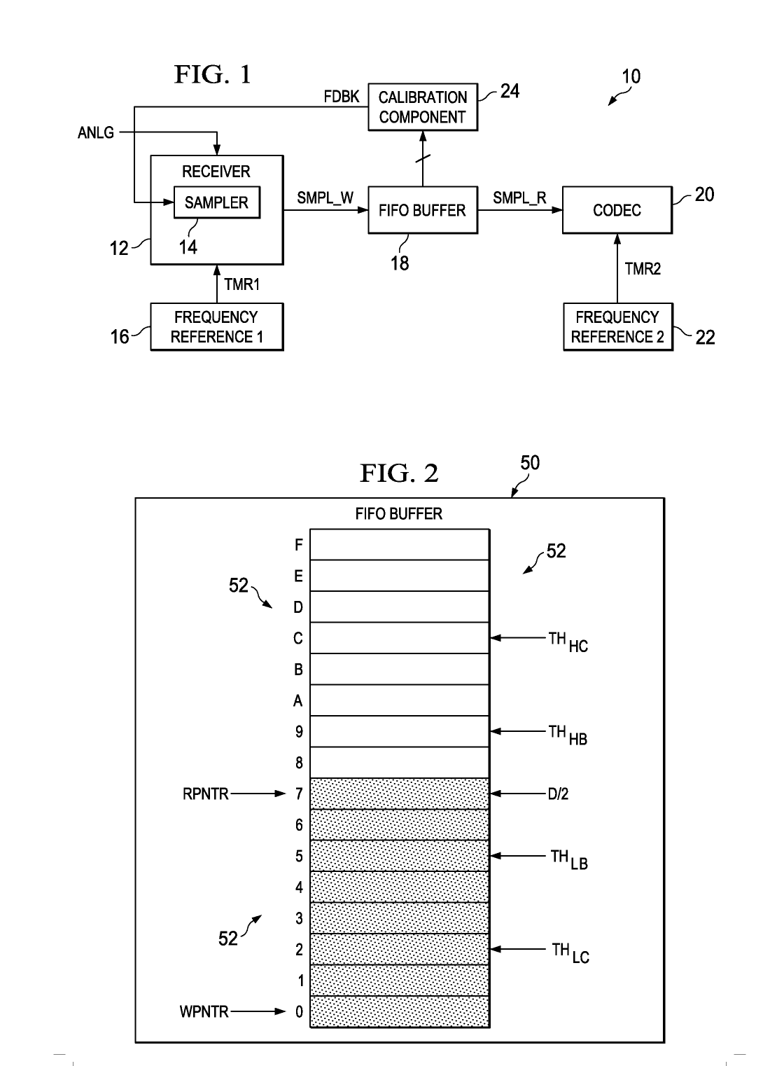

FIG. 1 illustrates an example of a receiver system 10 in accordance with an aspect of the invention. As an example, the receiver system 10 can be configured as an audio receiver system, such as to receive and demodulate a frequency modulated (FM) modulated analog audio signal. Thus, the receiver system 10 can be implemented in any of a variety of communications devices. In the following description of the example of FIG. 1, it is to be understood that the components of the receiver system 10 can be implemented as hardware (e.g., including firmware), software, or a combination of hardware and software.

The receiver system 10 includes a receiver 12 that receives an analog data signal ANLG. As an example, the analog data signal ANLG can be an audio signal, such as an FM modulated data signal, that is received via a wired connection or a wireless connection (e.g., from an antenna). The receiver 12 includes a digital sampler 14 that is configured to generate digital data samples associated with the analog data signal ANLG. In the example of FIG. 1, the digital sampler 14 can generate the digital data samples at a sampling frequency that is based on a first frequency reference 16 that provides a timer signal TMR1 to the receiver 12. As an example, the first frequency reference 16 can be configured as a real-time clock (RTC) frequency reference. Thus, the sampling frequency of the digital sampler 14 can be a frequency that is down-sampled from the frequency of the timer signal TMR1. The receiver can thus initiate write commands to provide the digital data samples, demonstrated in the example of FIG. 1 as SMPL_W, to a first-in first-out (FIFO) buffer 18 via a digital interface.

The receiver system 10 also includes a codec 20 that can operate as a host device with respect to the receiver 12. The codec 20 is configured to initiate read commands to read the digital data samples from the FIFO buffer 18. As an example, the codec 20 can be configured to initiate the read commands based on an integrated interchip sound (I²S) interface. In the example of FIG. 1, the digital data samples that are read by the codec 20 are demonstrated as SMPL_R which corresponds to the digital data samples SMPL_W that are written to the FIFO buffer 18 at a previous time. For example, as described in greater detail herein, the FIFO buffer 18 is configured to store a plurality of the digital data samples SMPL_W at a given time, such that the digital data samples SMPL_R that are read from the FIFO buffer 18 are delayed based on relative current states of a write pointer and a read pointer. The reading of the digital data samples SMPL_R from the FIFO buffer 18 can be performed via the read commands of the codec 20 at a read frequency that is based on a second frequency reference 22 that provides a timer signal TMR2 to the codec 20. As an example, the second frequency reference 22 can be configured as a system clock. For example, the read frequency can correspond to a frequency of the timer signal TMR2 itself, or can be a frequency that is down-converted from the frequency of the timer signal TMR2.

FIG. 2 illustrates an example of a FIFO buffer 50 in accordance with an aspect of the invention. The FIFO buffer 50 can correspond to the FIFO buffer 18 in the example of FIG. 1. Therefore, reference is to be made to the example of FIG. 1 in the following description of FIG. 2.

The FIFO buffer 50 is demonstrated in the example of FIG. 1 as including a plurality of cells 52, numbered in hexadecimal from “0” to “F”. It is to be understood that the FIFO buffer 50 is demonstrated with only sixteen cells 52 for simplicity, and that the FIFO buffer 50 can include many more cells 52. In the example of FIG. 2, cells “0” through “7” are demonstrated as shaded to indicate that they include digital data samples that have been written to the FIFO buffer 50 via write commands associated with the receiver 12. Thus, the FIFO buffer 50 includes a write pointer WPNTR that refers to the cell “0”, such that when a digital data sample SMPL_W is written to the FIFO buffer 50. As an example, the FIFO buffer 50 can be configured to implement a data shift of each of the digital data samples stored therein to a next contiguous cell 52 at each write command, such that a next digital data sample SMPL_W provided from the receiver 12 is written to the cell “0”.

The FIFO buffer 50 also includes a read pointer RPNTR that is demonstrated in the example of FIG. 2 as referring to digital data sample in the cell “7”. In response to a data shift that can occur in response to a write command, as described above, the read pointer RPNTR can likewise shift to continue referring to the same digital data sample both before and after the write command (e.g., from the cell “7” to the cell “8”). Upon a read command being provided via the codec 20 (e.g., via the I²S interface), the digital data sample referred to by the read pointer RPNTR (e.g., in cell “7”) can be read from the FIFO buffer 50 as a digital data sample SMPL_R. In response to the read command, the read pointer RPNTR can shift down to the previous contiguous cell 52 (e.g., from the cell “7” to the cell “6”). Therefore, the read pointer RPNTR can refer to the digital data sample in the previous contiguous cell 52, such that the next read command issued by the codec 20 will result in that digital data sample being provided from the FIFO buffer 50 to the codec 20. It is to be understood that the relative shifting of the digital data samples and the write and read pointers WPNTR and RPNTR with respect to the cells 52 are described herein by example, and that the FIFO buffer 50 can operate in any of a variety of different ways.

As a result of the operation of the write pointer WPNTR and the read RPNTR, the FIFO buffer 50 thus operates as a queue to store the digital data samples that are input to the FIFO buffer 50 prior to being read by the codec 20. Therefore, at a given time, the FIFO buffer 50 has a current pointer state that is defined as a difference between a current position of the read pointer RPNTR and a current position of the write pointer WPNTR with respect to the cells 52 of the FIFO buffer 50. Therefore, the current pointer state can be indicative of the number of digital data samples that are currently stored in the FIFO buffer 50.

If the sampling frequency at which the digital sampler 14 generates and provides the digital data samples SMPL_W to the FIFO buffer 50 is approximately the same as the read frequency at which the codec 20 reads the digital data samples SMPL_R from the FIFO buffer 50, then the current pointer state will not substantially change over time. However, a mismatch sampling frequency and the read frequency will result in a gradual drift of the current pointer state in one of a positive or negative direction. For example, if the sampling frequency is greater than the read frequency, then the current pointer state will drift in a positive direction (i.e., toward the cell “F”), which can result in an overflow of the digital data packets, such that one or more of the digital data packets can be dropped from the FIFO buffer 50 before it is read by the codec 20. Similarly, if the sampling frequency is less than the read frequency, then the current pointer state will drift in a negative direction (i.e., toward the cell “0”), which can result in an underflow of the digital data packets, such that one or more of the digital data packets is skipped by the codec 20. Such overflow and/or underflow of the digital data packets can result in a reduction of signal-to-noise ratio (SNR) of the resulting signal that is decoded by the codec 20, with the reduction in SNR being proportional to the magnitude of the frequency mismatch between the sampling frequency and the read frequency.

The FIFO buffer 50 also includes a predetermined pointer state D/2, a high bias threshold TH_{HB}, a high calibration threshold TH_{HC}, a low bias threshold TH_{LB}, and a low calibration threshold TH_{LC}. In the example of FIG. 2, the predetermined pointer state D/2 is associated with the cell “7”. As an example, at a given time, a desirable number of digital data samples can be approximately equal to the number of cells 52 of the FIFO buffer 50 divided by two, such that a rapid change in the drift of the current point state may not result in immediate overflow or underflow of the digital data samples stored in the FIFO buffer 50. Therefore, the predetermined pointer state D/2 can be associated with the cell 52 that corresponds to the number of cells 52 of the FIFO buffer 50 divided by two.

The high bias threshold TH_{HB}, demonstrated at the cell “9”, and the low bias threshold TH_{LB}, demonstrated at the cell “5”, can define a range of cells 52 within which the current pointer state (e.g., the read pointer in the example of FIG. 2) can reside for operation of the FIFO buffer 50 in a manner that is resilient to rapid changes in the drift of the current pointer state. In other words, based on the relative timing of the write commands and the read commands, it is unlikely that the current pointer state can remain at the predetermined pointer state D/2. Therefore, the high bias threshold TH_{HB} and the low bias threshold TH_{LB} can define a predetermined range of cells 52 for the current pointer state that can represent a desirable range for the current pointer state based on being associated with cells 52 that are relatively near and are above and below the cell 52 associated with the predetermined pointer state D/2.

The high calibration threshold TH_{HC}, demonstrated at the cell “C”, and the low calibration threshold TH_{LC}, demonstrated at the cell “2”, can be associated with respective maximum and minimum acceptable cells 52 that define a risk of overflow or underflow, respectively, of the FIFO 50. As an example, the high and low calibration thresholds TH_{HC} and TH_{LC} can correspond to relative predetermined or programmable offset values corresponding to an offset from an initial pointer state, such as the current pointer state from initialization of the receiver system 10 (e.g., the predetermined pointer state D/2), or the current pointer state after a calibration procedure. Thus, in the example of FIG. 2, the high and low calibration thresholds TH_{HC} and TH_{LC} can be saved with an offset value of +/−5 from the predetermined pointer state D/2 (e.g., an initial pointer state). As a result, subsequent to a calibration procedure, the initial pointer state be associated with a different cell 52 than the predetermined pointer state D/2, such that the high and low calibration thresholds TH_{HC} and TH_{LC} can be offset by +/−5 cells relative to that initial pointer state. As described herein, it is to be understood that the term “programmable” can be used to describe that a parameter is adjustable, such as during normal operation (e.g., by a processor or by a user) or during offline configuration (e.g., based on hardware or software control settings).

If the current pointer state (e.g., the read pointer in the example of FIG. 2) is equal to or greater than the high calibration threshold TH_{HC}, then the FIFO buffer 50 can be at risk of experiencing an overflow condition, such that one or more digital data samples can be dropped. Similarly, if the current pointer state is equal to or less than the low calibration threshold TH_{LC}, then the FIFO buffer 50 can be at risk of experiencing an underflow condition, such that one or more of the digital data packets is skipped by the codec 20. As described herein, the predetermined pointer state D/2, the high bias threshold TH_{HB}, the high calibration threshold TH_{HC}, the low bias threshold TH_{LB}, and the low calibration threshold TH_{LC} can be individually programmable relative to each other, or can be programmable as relative values with respect to each other. For example, the predetermined pointer state D/2 can be programmable, and the high and low bias thresholds TH_{HB} and TH_{LB} can be associated with programmable offsets relative to the predetermined pointer state D/2. Similarly, as described above, the high and low calibration thresholds TH_{HC} and TH_{LC} can be programmable offset values relative to an initial pointer state. In addition, it is to be understood that the offsets associated with high and low bias thresholds TH_{HB} and TH_{LB} and the high and low calibration thresholds TH_{HC} and TH_{LC} can be programmed as equal and opposite the predetermined pointer state D/2 and the initial pointer state, respectively, or can be individually programmable offsets. Alternatively, the high and low bias thresholds TH_{HB} and TH_{LB} and the high and low calibration thresholds TH_{HC} and TH_{LC} can be programmable with respect to specific cells 52 in the FIFO buffer 50.

Referring back to the example of FIG. 1, the receiver system 10 further includes a calibration component 24 that is configured to monitor the FIFO buffer 18 and to control the sampling frequency of the digital sampler 14 to substantially control the current pointer state of the FIFO buffer 18 to be maintained approximately near the predetermined pointer state D/2 (e.g., within the high and low bias thresholds TH_{HB} and TH_{LB}). As an example, the calibration component 24 can calculate a frequency offset (e.g., in parts per million (PPM)) between the sampling frequency and the read frequency. The frequency offset can be based on a difference between relative occurrence of the write commands and the read commands associated with the FIFO buffer 50, such that the calibration component 24 can determine a frequency offset based on an amount of time it took for the current pointer state to drift to a predetermined threshold (e.g., the high and low calibration thresholds TH_{HC} and TH_{LC}). Therefore, the calibration component 24 can adjust the sampling frequency of the digital sampler 14 in a feedback manner via a signal FDBK based on the frequency offset. Accordingly, the current pointer state of the FIFO buffer 18 can be maintained approximately near the predetermined pointer state D/2 to substantially mitigate overflow and/or underflow of the FIFO buffer 18, and thus substantially mitigate degradation of SNR of the resulting signal decoded by the codec 20.

As a result, the receiver system 10 can substantially mitigate degradation of SNR for a receiver system with non-uniform frequency references with respect to both the receiver 12 and the host device (i.e., the codec 20). In addition, as described in greater detail herein, the calibration of the receiver system 10 to set the calibration frequency to be approximately equal to the read frequency can be interrupt based, such that it may only be performed when necessary. The receiver system 10 can thus dynamically track frequency changes efficiently and at lower power, as opposed to receiver systems that implement a common frequency reference for the receiver and host device. Furthermore, as described in greater detail herein, by maintaining the current pointer state of the FIFO buffer 18 approximately near the predetermined pointer state D/2, the receiver system 10 can be substantially resistant to substantially instantaneous sample jitters.

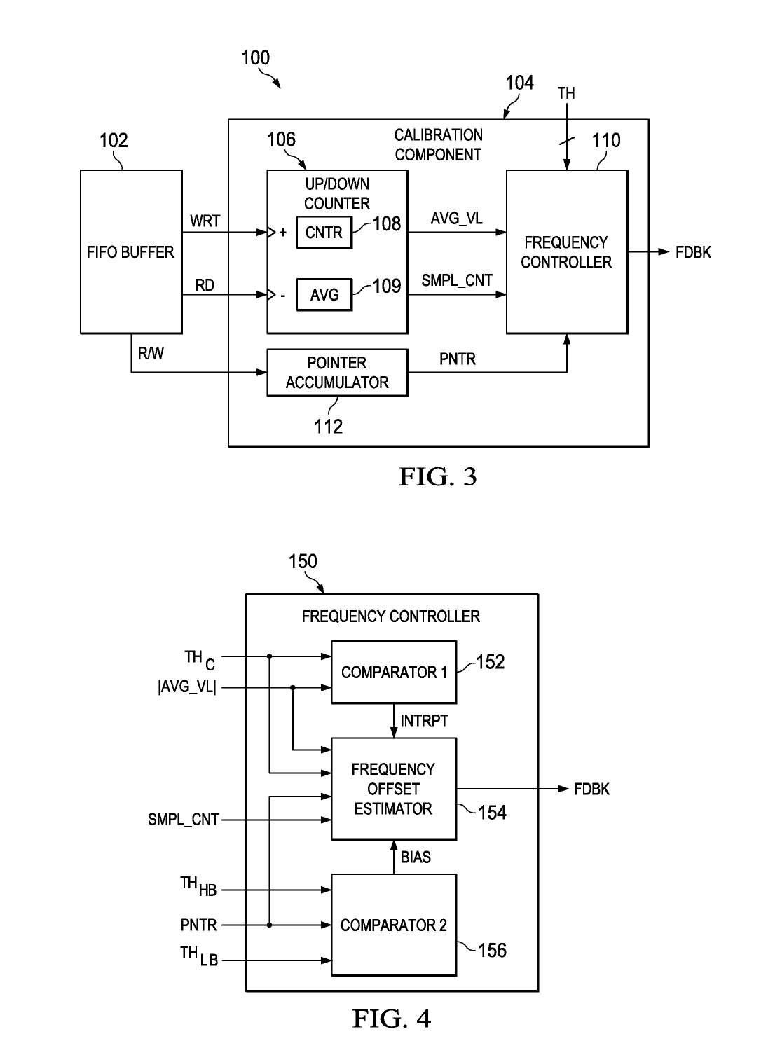

FIG. 3 illustrates another example of a receiver system 100 in accordance with an aspect of the invention. The receiver system 100 includes a FIFO buffer 102 and a calibration component 104. The FIFO buffer 102 can correspond to the FIFO buffer 18 and/or the FIFO buffer 50 in the examples of FIGS. 1 and 2, respectively, and the calibration component 104 can correspond to the calibration component 24 in the example of FIG. 1. Therefore, reference is to be made to the examples of FIGS. 1 and 2 in the following description of the example of FIG. 3.

In the example of FIG. 3, the FIFO buffer 102 is configured to generate a signal WRT that corresponds to occurrence of a write command instance and a signal RD that corresponds to occurrence of a read command instance. The calibration component 104 includes an up/down counter 106 that is configured to receive the signals WRT and RD at respective inputs. In response to receiving the signal WRT, the up/down counter 106 increments a difference count value 108, demonstrated as CNTR in the example of FIG. 3. Similarly, in response to receiving the signal RD, the up/down counter 106 decrements the difference count value 108. Therefore, the difference count value 108 stores an instantaneous difference between the occurrence of write commands and read commands. As an example, the difference count value 108 can be set to an initial value of zero at initialization of the receiver system 10, in response to an interrupt, and/or in response to the current pointer state being equal to the predetermined pointer state. In addition, the up/down counter 106 includes an averaging block 109, demonstrated as AVG in the example of FIG. 3, that is configured to generate a moving block average of difference count value 108 (e.g., since a last hardware or software interrupt, initialization, and/or reset). Therefore, the average count value 109 can have a polarity that is indicative of whether the current pointer state is drifting in a positive direction or a negative direction in the FIFO buffer 102.

The calibration component 104 also includes a frequency controller 110. At initialization of the frequency controller 110, the frequency controller 110 can be loaded with a default frequency offset of zero PPM. After operation of the receiver system 100 commences, the up/down counter 106 provides the average count value 109 to the frequency controller 110 via a signal AVG_VL and a total sample count value corresponding to the total write commands to the frequency controller 110 via a signal SMPL_CNT. In addition, the frequency controller 110 receives the current pointer state, demonstrated in the example of FIG. 3 as via a signal PNTR that is generated by a pointer accumulator 112. In the example of FIG. 3, the FIFO buffer 102 provides a signal R/W to the pointer accumulator 112, which can correspond to the respective cell positions of the read pointer RPNTR and the write pointer WPTNR. Thus, the current pointer state PNTR can correspond to the difference between the read pointer RPNTR and the write pointer WPNTR.

The frequency controller 110 can be configured to compare the average count value AVG_VL to the threshold, such as one of the high and low calibration thresholds TH_{HC} and TH_{LC}, directly. For example, the average count value AVG_VL can be compared with the offset value from the initial pointer state (i.e., an offset of +/−5 in the example of FIG. 2), such that the frequency controller 110 compares like comparison terms, such as based on the difference count value 108 being reset to zero at initialization of the receiver system 10 or in response to an interrupt. Upon the average count value AVG_VL being greater than or equal to the threshold, the frequency controller 110 can generate an interrupt signal (not shown in the example of FIG. 3) that initiates calibration of the receiver system 10, such that the sampling frequency of the digital sampler 14 is adjusted. In other words, the frequency controller 110 may adjust the sampling frequency of the digital sampler 14 only when it is determined to be necessary, such as in response to the average count value AVG_VL being greater than or equal to the threshold, and thus at a time when the FIFO buffer 102 is at risk for an overflow or underflow condition. Furthermore, because the frequency controller 110 initiates the calibration of the receiver system 10 based on comparison of the threshold with the average count value 109, as opposed to the difference count value 108, erroneous calibrations of the receiver system 10 that can result from instantaneous jitters of the current pointer state can be substantially mitigated.

In response to the initiation of a calibration procedure, the frequency controller 110 is configured to calculate a frequency offset corresponding to a difference between the sampling frequency and the read frequency based on the sample count value SMPL_CNT and the current pointer state PNTR. As an example, the frequency controller 110 can determine the number of write commands (i.e., the sample count value SMPL_CNT) that occurred until the average count value AVG_VL reached the threshold, such as one of the high and low calibration thresholds TH_{HC} and TH_{LC}. Thus, the amount of time corresponding to the sample count value SMPL_CNT can thus correspond to the frequency offset. In the example of FIG. 3, the threshold is demonstrated as a signal TH, such that the threshold can be programmable. As an example, the threshold signal TH can be provided to the frequency controller 110 (e.g., from an associated processor), or can be generated internal to the frequency controller 110, to program the appropriate cells for FIFO buffer 102 that define the high and low bias thresholds TH_{HB} and TH_{LB}, the high and low calibration thresholds TH_{HC} and TH_{LC}, and/or the predetermined pointer state D/2, as described in the example of FIG. 2.

The frequency offset can thus be provided via the feedback signal FDBK that is provided to the receiver 12 to change the sampling frequency of the digital sampler 14 in response to the initiation of the calibration procedure. As an example, the sampling frequency of the digital sampler 14 can be adjusted by an amount that is approximately equal to the frequency offset to substantially mitigate the frequency mismatch between the sampling frequency and the read frequency. In addition, the frequency controller 110 can be configured to move the current pointer state PNTR to within an approximate optimal cell location in the FIFO buffer 102, such as based on adding a digital bias to the frequency offset.

FIG. 4 illustrates an example of a frequency controller 150 in accordance with an aspect of the invention. The frequency controller 150 can correspond to the frequency controller 110 in the example of FIG. 3, such as can be included in the calibration component 24 in the example of FIG. 1. Therefore, reference is to be made to the examples of FIGS. 1 through 3 in the following description of the example of FIG. 4.

The frequency controller 150 includes a first comparator 152. The first comparator 152 is configured to compare an absolute value of the average count value AVG_VL with a calibration threshold TH_{C}. The calibration threshold TH_{C} can correspond to both the high calibration threshold TH_{HC} and the low calibration threshold TH_{LC} arranged equally and oppositely with respect to the predetermined pointer state D/2 in the example of FIG. 2. Therefore, the calibration threshold TH_{C} can be an absolute value of a maximum acceptable threshold for drift of the current pointer state in either the positive or negative direction in the FIFO buffer 50. Therefore, upon the absolute value of the average count value AVG_VL being equal to or greater than the calibration threshold TH_{C}, the FIFO buffer 50 is at risk of experiencing an overflow or underflow condition. Therefore, the first comparator 152 is configured to generate an interrupt signal INTRPT in response to the average count value AVG_VL being equal to or greater than the calibration threshold TH_{C}. The interrupt signal INTRPT is thus indicative of initiation of a calibration procedure to adjust the sampling frequency of the digital sampler 14 to substantially mitigate degradation of SNR of the receiver system 10, as described herein.

The frequency controller 150 also includes a frequency offset estimator 154 that is activated in response to the interrupt signal INTRPT. The frequency offset estimator 154 is configured to receive the absolute value of the average count value AVG_VL, the calibration threshold TH_{C}, the current pointer state PNTR, and the sample counts SMPL_CNT and to determine an amount of time that has elapsed since a last hardware reset (e.g., previous interrupt initiating calibration procedure, hardware activation, etc.) before the average count value AVG_VL reached the calibration threshold TH_{C}. As an example, the rate of drift associated with the current pointer state PNTR can be indicative of the frequency offset in PPM, as indicated by the average count value AVG_VL and the sample counts value SMPL_CNT. As an example, the sample counts value SMPL_CNT can define a time interval during which the average count value AVG_VL indicates a drift of the current pointer state with respect to the mismatch between occurrence of a write commands and read commands. Therefore, in response to the interrupt signal INTRPT, a current frequency offset FrequencyOffset between the sampling frequency and the read frequency can be calculated as follows:

FrequencyOffset=Sign*Thresh/Sample Count Equation 1
Where:
   Sign=the polarity of the average count value AVG_VL;
   Thresh=the calibration threshold TH_{C};
   Sample Count=the sample count value SMPL_CNT.

Accordingly, based on the sampling frequency of the digital sampler 14 and the number of write commands having occurred before the average count value AVG_VL drifted to the calibration threshold TH_{C}, the frequency offset estimator 154 can estimate the frequency offset in PPM between the sampling frequency and the read frequency. The frequency offset estimator 154 can thus provide the current frequency offset to the digital sampler 14 via the feedback signal FDBK.

By way of example, after initialization of the calibration procedure, the calibration threshold TH_{C} can be reprogrammed as offset from the initial pointer state (i.e., the current pointer state immediately after the calibration procedure), such as to redefine the high and low calibration thresholds TH_{HC} and TH_{LC} relative to the initial pointer state. Thus, after the calibration procedure, additional calibration can subsequently be performed, such as at each instance of the interrupt signal INTRPT, as described above. As an example, the current frequency offset that is calculated in Equation 1 can be added to a previous frequency offset between the sampling frequency and the read frequency to set the sampling frequency to be approximately equal to the read frequency. The calibration component 100 can thus be programmed with the sufficient configuration information to begin monitoring the relative read and write commands, such as to perform another calibration operation at a later time, if necessary. Accordingly, the calibration component 100 can be configured to correct frequency offset estimation errors and/or changes in the frequency offset.

Upon correction of the sampling frequency by the frequency offset via the feedback signal FDBK, the sampling frequency should thus be approximately equal to the read frequency. As a result, the write commands and the read commands should occur at approximately the same frequency, such that drift of the current pointer state PNTR should be substantially mitigated. However, if the current pointer state PNTR is located in the FIFO buffer 50 at a cell 52 that is near one of the high or low calibration thresholds TH_{HC} or TH_{LC} after the sampling frequency is adjusted by the frequency offset, the FIFO buffer 50 could still be at risk for an overflow or underflow condition, respectively, or could allow for a triggering of the interrupt signal INTRPT by the first comparator 152. Therefore, the frequency controller 150 can be configured to implement phase correction for the current pointer state PNTR by moving the current pointer state PNTR to within a predetermined pointer state range, such as between the high and low bias thresholds TH_{HB} and TH_{LB}.

The frequency controller 150 includes a second comparator 156. The second comparator 156 is configured to compare the current pointer state PNTR with both the high bias threshold TH_{HB} and the low bias threshold TH_{LB} to determine if the current pointer state PNTR is outside of the predetermined pointer state range. If the current pointer state PNTR is greater than the high bias threshold TH_{HB} or less than the low bias threshold TH_{LB}, then the current pointer state PNTR is not within the predetermined pointer state range. In response, the second comparator 156 is configured to generate a digital bias, demonstrated in the example of FIG. 4 as a signal BIAS that is provided to the frequency offset estimator 154. The frequency offset estimator 154 can thus add the digital bias BIAS to the frequency offset, such that the feedback signal FDBK is implemented to adjust the sampling frequency by an amount that is a sum of the frequency offset and the digital bias BIAS. Therefore, the current pointer state PNTR can be moved back to within the predetermined pointer state range.

As an example, the second comparator 156 can continuously monitor the current pointer state PNTR relative to both the high and low bias thresholds TH_{HB} and TH_{LB}, such that the digital bias BIAS can be deactivated or reset upon the current pointer state PNTR being less than the high bias threshold TH_{HB} or greater than the low bias threshold TH_{LB}. As another example, the digital bias BIAS can be deactivated upon the current pointer state PNTR being approximately equal to the predetermined pointer state D/2 or a range of cells around the predetermined pointer state D/2 that is more narrow than the range of cells between the high and low bias thresholds TH_{HB} and TH_{LB}. The magnitude of the digital bias BIAS static, or can be based on the comparison of the current pointer state PNTR with the high and low bias thresholds TH_{HB} and TH_{LB}, such that the digital bias BIAS can have a magnitude that is proportional to the distance of the current pointer state PNTR from the predetermined pointer state D/2. Furthermore, as yet another example, in response to activation of or conclusion of the phase correction of the current pointer state PNTR, the calibration threshold TH_{C} can be reprogrammed as corresponding to offsets from the current pointer state either during or after conclusion of the phase correction. Accordingly, the phase correction of the current pointer state PNTR can ensure that the FIFO buffer 50 continuously operates more efficiently within the predetermined pointer state range.

It is to be understood that the receiver systems 10 and 100, the FIFO buffer 50, and the frequency controller 150 are not intended to be limited to the examples of FIGS. 1 through 4. As an example, despite the frequency controller 150 implementing use of the absolute value of the average count value AVG_VL and the single calibration threshold TH_{C}, the calibration threshold TH_{C} can correspond to separately programmable high and low calibration thresholds TH_{HC} and TH_{LC}. Therefore, the frequency controller 150 can implement the thresholds separately for comparison and for determining the frequency offset. Furthermore, it is to be understood that the interrelations of the components demonstrated in the examples of FIGS. 1 through 4 are demonstrated for the sake of simplicity, but that the separate hardware, firmware, and software functionality of the components described herein can be arranged in a variety of ways. For example, while the receiver system 10 can be implemented as a single device, it is to be understood that the receiver system 10 can correspond to other receiver arrangements. As an example, the receiver system 10 can correspond to separate devices in an FM transmit mode, such that the receiver 12 can correspond to an external host driven unit that is a source of the audio samples and an FM transmitter (FM IP) acts as the receiver of the audio samples.

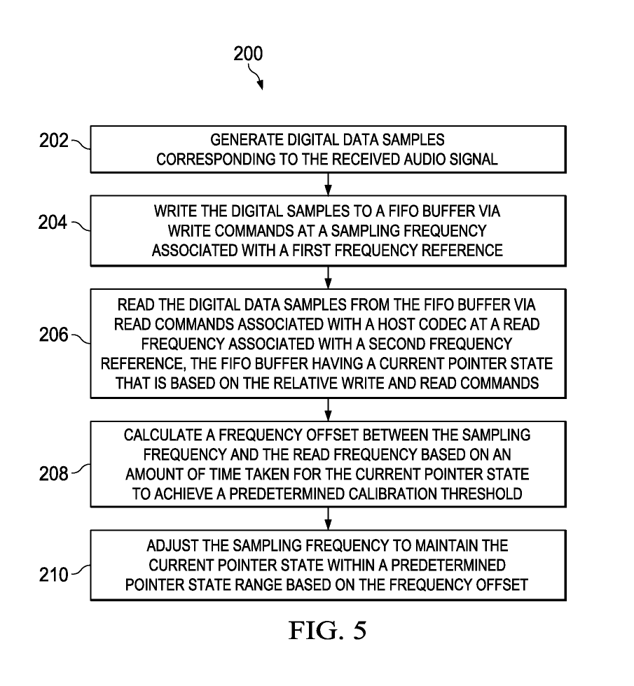

In view of the foregoing structural and functional features described above, a methodology in accordance with various aspects of the present invention will be better appreciated with reference to FIG. 5. While, for purposes of simplicity of explanation, the methodology of FIG. 5 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect of the present invention.

FIG. 5 illustrates an example of a method 200 for substantially reducing a signal-to-noise ratio of a received audio signal. At 202, digital data samples corresponding to the received audio signal are generated. The digital data samples can be generated by a digital sampler in a receiver. At 204, the digital data samples are written to a FIFO buffer via write commands at a sampling frequency associated with a first frequency reference. At 206, the digital data samples are read from the FIFO buffer via read commands associated with a host codec at a read frequency associated with a second frequency reference, the FIFO buffer having a current pointer state that is based on the relative write and read commands. The reading of the digital data samples from the FIFO buffer can be based on a digital interface, such as I²S.

At 208, a frequency offset between the sampling frequency and the read frequency is calculated based on an amount of time taken for the current pointer state to achieve a predetermined calibration threshold. The frequency offset can be based on determining a count value associated with a difference between write commands and read commands over the time interval. Therefore, an amount of time, such as a corresponding to a number of write commands at the sampling frequency, which the current pointer state drifted to a threshold can be determined. At 210, the sampling frequency is adjusted to maintain the current pointer state within a predetermined pointer state range based on the frequency offset. The maintaining of the current pointer state to between the optimal thresholds can also be based on a digital bias that is added to the frequency offset to move the current pointer state toward the predetermined pointer state.

What have been described above are examples of the invention. It is, of course, not possible to describe every conceivable combination of components or methodologies for purposes of describing the invention, but one of ordinary skill in the art will recognize that many further combinations and permutations of the invention are possible. Accordingly, the invention is intended to embrace all such alterations, modifications, and variations that fall within the scope of this application, including the appended claims.

What is claimed is:

1. A receiver system comprising:
a receiver configured to generate digital data samples corresponding to a received analog signal at a sampling frequency associated with a first frequency reference;
a host codec configured to read the digital data samples at a read frequency associated with a second frequency reference;
a first-in first-out (FIFO) buffer configured to buffer the digital data samples via write commands associated with the receiver and read commands associated with the host codec, the FIFO buffer having a current pointer state that is based on the relative write and read commands; and
a frequency controller configured to calculate a frequency offset between the sampling frequency and the read frequency based on a rate of drift of the current pointer state relative to a predetermined calibration threshold and to adjust the sampling frequency based on the calculated frequency offset.

2. The system of claim 1, wherein the calibration component is configured to calculate the frequency offset based on calculating an amount of time that it takes for the current pointer state to reach the predetermined calibration threshold based on a difference between occurrence of write commands and read commands over a time interval.

3. The system of claim 1, wherein the current pointer state corresponds to a difference between a current write pointer position of the FIFO buffer and a current read pointer position of the FIFO buffer, and wherein the predetermined calibration threshold comprises a first frequency correction threshold corresponding to a maximum pointer state and a second threshold corresponding to a minimum pointer state.

4. The system of claim 1, wherein the calibration component comprises an up/down counter configured to maintain a difference count value corresponding to a difference between the write commands and the read commands during a time interval and to generate a sample count value corresponding to a total number of write commands over the time interval.

5. The system of claim 4, wherein the calibration component further comprises a frequency controller configured to generate a feedback signal in response to the sample count value and the current pointer state, the feedback signal being provided to the receiver to adjust the sampling frequency of a digital sampler that initiates the write commands.

6. The system of claim 5, wherein the frequency controller is further configured to generate an average count value corresponding to a moving block average of the difference count value and comprises a comparator configured to compare the average count value with the predetermined calibration threshold, the comparator initiating the adjustment of the sampling frequency in response to the average count value being greater than or equal to the predetermined calibration threshold.

7. The system of claim 5, wherein the frequency controller comprises a comparator configured to compare the current pointer state with a high bias threshold and a low bias threshold, the high and low bias thresholds corresponding to respective pointer states that are respectively greater than and less than a predetermined pointer state, the comparator generating a digital bias that is added to the adjustment of the sampling frequency in response to the current pointer state being one of greater than the high bias threshold and less than the low bias threshold to move the current pointer state to between the high bias threshold and the low bias threshold.

8. The system of claim 5, wherein the frequency controller comprises a frequency offset estimator configured to calculate the frequency offset based on the sample count value upon the current pointer state reaching the predetermined calibration threshold.

9. The system of claim 1, wherein the host codec is configured to generate the read commands based on an integrated interchip sound (I²S) interface.

10. An audio receiver system comprising the receiver system of claim 1 and configured to substantially increase a signal-to-noise ratio (SNR) of an audio signal corresponding to the received analog signal.

11. A method for substantially increasing a signal-to-noise ratio (SNR) of a received audio signal, the method comprising:
generating digital data samples corresponding to the received audio signal;
writing the digital data samples to a first-in first-out (FIFO) buffer via write commands at a sampling frequency associated with a first frequency reference;
reading the digital data samples from the FIFO buffer via read commands associated with a host codec at a read frequency associated with a second frequency reference, the FIFO buffer having a current pointer state that is based on the relative write and read commands;
calculating a frequency offset between the sampling frequency and the read frequency reference based on an amount of time taken for the current pointer state to achieve a predetermined calibration threshold; and
adjusting the sampling frequency to maintain the current pointer state within a predetermined pointer state range based on the frequency offset.

12. The method of claim 11, wherein calculating the frequency offset comprises calculating a number of write commands until the predetermined calibration threshold is reached from the current pointer state based on an average count value corresponding to a moving block average of a difference between occurrence of write commands and read commands, the predetermined calibration threshold comprising a high calibration threshold corresponding to a maximum pointer state and a low calibration threshold corresponding to a minimum pointer state, the current pointer state corresponding to a difference between a current write pointer position of the FIFO buffer and a current read pointer position of the FIFO buffer.

13. The method of claim 12, further comprising comparing the average count value with the predetermined calibration threshold, wherein adjusting the sampling frequency comprises initiating adjustment of the sampling frequency in response to the average count value being greater than or equal to the threshold.

14. The method of claim 11, wherein controlling the sampling frequency comprises changing the sampling frequency by the frequency offset to substantially mitigate a difference between the sampling frequency and the read frequency.

15. The method of claim 14, further comprising:
comparing the current pointer state with a high bias threshold and a low bias threshold, the high and low bias thresholds defining the predetermined pointer state range;
generating a digital bias that is added to the frequency offset in response to the current pointer state being one of greater than the high bias threshold and less than the low bias threshold to move the current pointer state to between the high bias threshold and the low bias threshold.

16. The method of claim 11, wherein reading the digital data samples comprises reading the digital data samples via the read commands based on an integrated interchip sound (I²S) interface.

17. An audio receiver system comprising:
a receiver configured to generate digital data samples corresponding to a received audio signal at a sampling frequency associated with a first frequency reference;
a host codec configured to read the digital data samples at a read frequency associated with a second frequency reference based on an integrated interchip sound (I²S) interface;
a first-in first-out (FIFO) buffer configured to buffer the digital data samples via write commands associated with the receiver and read commands associated with the host codec, the FIFO buffer having a current pointer state that is based on the relative write and read commands; and
a calibration component configured to determine a difference count value corresponding to a difference between relative occurrence of write commands and read commands, to calculate a frequency offset between the sampling frequency and the read frequency reference based on calculating a number of write commands until a predetermined calibration threshold is reached from the current pointer state based on the difference count value, and to adjust the sampling frequency based on the frequency offset.

18. The system of claim 17, wherein the calibration component comprises an up/down counter configured to maintain a count value corresponding to the difference between the write commands and the read commands during the time interval and to generate a sample count value corresponding to a total number of write commands over the time interval, the calibration component calculating the frequency offset based on the sample count value and the current pointer state.

19. The system of claim 17, wherein the calibration component is further configured to generate an average count value corresponding to a moving block average of the difference count value and further comprises a comparator configured to compare the average count value with the predetermined calibration threshold, the comparator being configured to initiate adjustment of the sampling frequency in response to the count value being greater than or equal to the predetermined calibration threshold.

20. The system of claim 17, wherein the frequency controller comprises a comparator configured to compare the current pointer state with a high bias threshold and a low bias threshold, the high and low bias thresholds corresponding to respective pointer states that are respectively greater than and less than a predetermined pointer state, the comparator generating a digital bias that is added to the frequency offset in response to the current pointer state being one of greater than the high bias threshold and less than the low bias threshold to move the current pointer state to between the high bias threshold and the low bias threshold.
